(19) United States
(12) Patent Application Publication
(10) Pub. No.: US 2006/0233150 A1
(43) Pub. Date: Oct. 19, 2006

(54) Method and apparatus for providing control channel monitoring in a multi-carrier system

(76) Inventor: George Cherian, San Diego, CA (US)

Correspondence Address: DITTHAVONG & MORI, P.C., Suite A, 10507 Braddock Road, Fairfax, VA, 22032, US

(21) Appl. No.: 11/404,300

(22) Filed: Apr. 14, 2006

Related U.S. Application Data
(60) Provisional application No. 60/671,658, filed on Apr. 15, 2005.

(51) Int. Cl. H04B 7/216

(52) U.S. Cl. 370/342

(57) ABSTRACT

An approach is provided for providing control of multiple traffic channels using a single control channel in multi-carrier communication system. A terminal monitors, while connected to the multi-carrier communication system, a control channel supported over one of a plurality of carriers. The one carrier is pre-designated as a primary carrier for the control channel.

### RELATED APPLICATIONS

This application claims the benefit of the earlier filing date under 35 U.S.C. §119(e) of U.S. Provisional Application Ser. No. 60/671,658 filed Apr. 15, 2005, entitled “Method and System for Providing Control of Multiple Traffic Channels Using a Single Control Channel,” the entirety of which is incorporated by reference.

### FIELD OF THE INVENTION

Various exemplary embodiments of the invention relate generally to communicating in multi-carrier communication system.

### BACKGROUND

Radio communication systems, such as cellular systems (e.g., Code Division Multiple Access (CDMA) network), provide users with the convenience of mobility along with a rich set of services and features. This convenience has spawned significant adoption by an ever growing number of consumers as an accepted mode of communication for business and personal uses in terms of communicating voice, texts and graphical messages. As a result, cellular service providers are continually challenged to enhance their networks and services as well as increase their customer base. These objectives place a premium on efficient management of network capacity.

Multi-carriers (channels) play a role critical in coherent CDMA communications for higher throughput on the traffic channel by using a plurality of carriers at the same time for applying allocation information. Unfortunately, conventional techniques for providing multi-carriers do not address how the control channel monitoring could be efficiently performed when multi-forward traffic channels are aggregated.

It is recognized that there is a need for an approach to efficiently performing control channel.

### SUMMARY OF SOME EXEMPLARY EMBODIMENTS

These and other needs are addressed by various embodiments of the invention, in which an approach is presented for channel control monitoring in a multi-carrier communication system.

According to one aspect of an embodiment of the invention, a method comprises monitoring, while connected to a multi-carrier communication system, a control channel supported over one of a plurality of carriers. The one carrier is pre-designated as a primary carrier for the control channel.

According to another aspect of an embodiment of the invention, an apparatus comprises a processor configured to monitor, while connected to a multi-carrier communication system, a control channel supported over one of a plurality of carriers. The one carrier is pre-designated as a primary carrier for the control channel.

According to another aspect of an embodiment of the invention, a method comprises designating, within a multi-carrier communication system, one of a plurality of carriers as a primary carrier for supporting a control channel. An access terminal is configured to monitor the control channel to obtain supervisory information.

According to another aspect of an embodiment of the invention, an apparatus comprises a transceiver configured to receive a time-warping parameter from a terminal for time-warping of speech over a communication system, wherein the time-warping parameter is determined by the terminal based on channel condition of the communication or loading of the communication system. The terminal dynamically adjusts playout of the speech in response to the channel condition or the loading.

According to another aspect of an embodiment of the invention, a method comprises establishing communication with a cellular communication system configured to provide high data rate service utilizing a plurality of carriers, wherein a single one of the carriers is designated for providing control channel supervision. The method also comprises receiving, during a connected state, a control channel message transmitted via the single carrier.

According to yet another aspect of an embodiment of the invention, an apparatus comprises means for establishing communication with a cellular communication system configured to provide high data rate service utilizing a plurality of carriers, wherein a single one of the carriers is designated for providing control channel supervision. Additionally, the apparatus comprises means for receiving, during a connected state, a control channel message transmitted via the single carrier.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The invention is illustrated by way of example, and not by way of limitation, in the figures of the accompanying drawings in which like reference numerals refer to similar elements and in which:

FIG. 1 is a diagram of the architecture of a multi-carrier communication system including an Access Node (AN) and an Access Terminal (AT) configured to perform control channel monitoring, in accordance with an embodiment of the invention;

FIG. 2 is a diagram an AN and an AT utilizing a primary channel for exchanging overhead messages, in accordance with an embodiment of the invention;

FIG. 3 is a flowchart of a process for performing control channel supervision using a primary carrier, in accordance with an embodiment of the invention;

FIGS. 4A and 4B are diagrams of an exemplary message format of a configuration message utilized in the system of FIG. 1, in accordance with various embodiments of the invention;

FIGS. 5A-5C are diagrams of an exemplary message format of a sector parameter message utilized in the system of FIG. 1, in accordance with various embodiments of the invention;

FIG. 6 is a diagram of hardware that can be used to implement various embodiments of the invention;

FIGS. 7A and 7B are diagrams of different cellular mobile phone systems capable of supporting various embodiments of the invention;

FIG. 8 is a diagram of exemplary components of a mobile station capable of operating in the systems of FIGS. 7A and 7B, according to an embodiment of the invention; and

FIG. 9 is a diagram of an enterprise network capable of supporting the processes described herein, according to an embodiment of the invention.

### DESCRIPTION OF THE PREFERRED EMBODIMENT

An apparatus, method, and software for providing control channel monitoring mechanism that can be performed when multiple forward traffic channels (e.g., an integer (N) number of carriers) are aggregated. The invention, according to one embodiment, addresses, among other issues, the issue of how control channel monitoring is performed are disclosed. In the following description, for the purposes of explanation, numerous specific details are set forth in order to provide a thorough understanding of the invention. It is apparent, however, to one skilled in the art that the invention may be practiced without these specific details or with an equivalent arrangement. In other instances, well-known structures and devices are shown in block diagram form in order to avoid unnecessarily obscuring the embodiments of the invention.

Although the invention, according to various embodiments, is discussed with respect to a radio communication network (such as a cellular system), it is recognized by one of ordinary skill in the art that the embodiments of the invention have applicability to any type of communication systems, including wired systems.

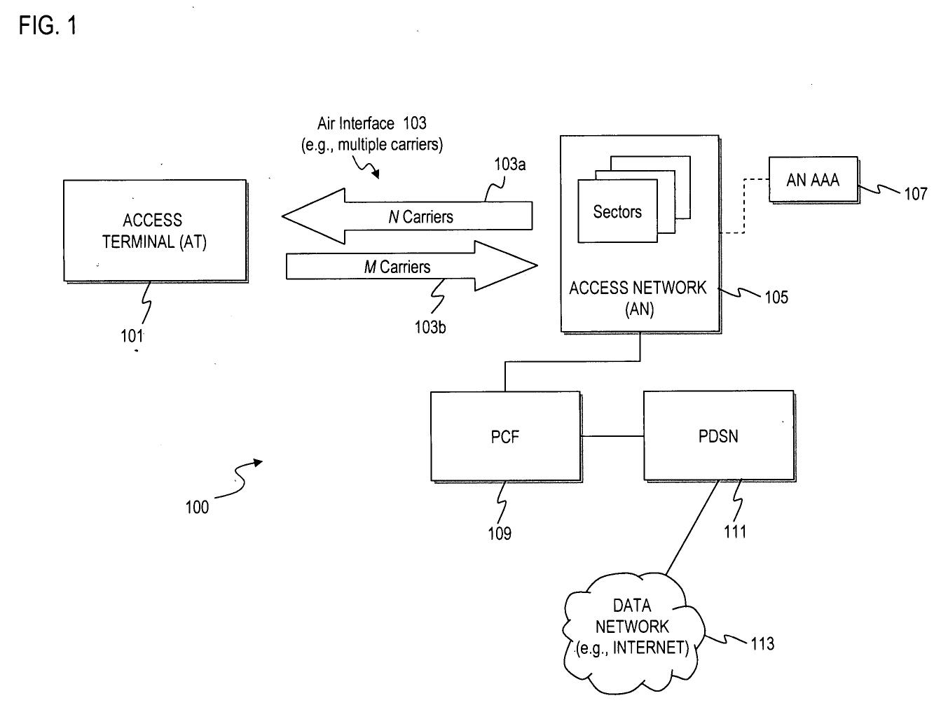

FIG. 1 is a diagram of the architecture of a multi-carrier communication system including an Access Node (AN) and an Access Terminal (AT) configured to perform control channel monitoring, in accordance with an embodiment of the invention. For the purposes of illustration, a radio network 100 operates according to the Third Generation Partnership Project (3GPP) cdma2000 Multi-Carrier Requirements in Code Division Multiple Access (CDMA) N×EV-DO (Evolution Data-Only) networks, and provides High Rate Packet Data (HRPD) services. The radio network 100 includes one or more access terminals (ATs) 101 of which one AT 101 is shown in communication with an access network (AN), or base station, 105 over an air interface 103. In cdma2000 systems, the AT is equivalent to a mobile station, and the access network is equivalent to a base station. The air interface 103 provides multiple carriers in the forward link 103a as well as the reverse link 103b.

The AT 101 is a device that provides data connectivity to a user. For example, the AT 101 can be connected to a computing system, such as a personal computer, a personal digital assistant, etc. or a data service enabled cellular handset. The radio configuration encompasses two modes of operations: 1× and multi-carrier (i.e., n× or N number of carriers). Multi-carrier systems (e.g., system 100) employ multiple 1× carriers to increase the data rate to the AT 101 (or mobile station) over the forward link. Hence, unlike 1× technology, the multi-carrier system operates over multiple carriers. In other words, the AT 101 is able to access multiple carriers simultaneously.

Multi-carrier systems can achieve higher throughput on the traffic channel. However, it recognized that control channel monitoring poses an interesting challenge. The system 100, according to exemplary embodiments, control channel messages (i.e., overhead messages) are transmitted only on a primary carrier within the N carriers. Thus, the system 100 performs control channel supervision on a single carrier, while in the connected state, within the multi-carrier environment.

A connection can be defined as a particular state of the air-link in which the AT 101 is assigned a Forward Traffic Channel, a Reverse Traffic Channel and associated Medium Access Control (MAC) Channels. During a single HRPD session, the AT 101 and the AN 105 can open and can close a connection multiple times. An HRPD session refers to a shared state between the AT 101 and the AN 105. This shared state stores the protocols and protocol configurations that were negotiated and are used for communications between the AT 101 and the AN 105. Other than to open a session, the AT 101 cannot communicate with the AN 105 without having an open session. A more detailed description of the HRPD is provided in 3GPP2 C.S0024-A, entitled “cdma2000 High Rate Packet Data Air Interface Specification,” March 2004, 3GPP2 A.S0007-A v2.0, entitled “Interoperability Specification (IOS) for High Rate Packet Data (HRPD) Access Network Interfaces—Rev. A,” May 2003, and 3GPP2 A.S0008-0 v3.0, entitled “Interoperability Specification (IOS) for High Rate Packet Data (HRPD) Access Network Interfaces,” May 2003; which are incorporated herein by reference in their entireties.

The AN 105 is a network equipment or network element that provides data connectivity between a packet switched data network, such as the global Internet 113 and the AT 101. In addition, the AN 105 communicates with an AN-AAA (Authentication, Authorization and Accounting entity) 107, which provides terminal authentication and authorization functions for the AN 105.

According to various embodiments, the AN 105 includes a High Data Rate (HDR) base station to support high data rate services. It should be understood that the base station provides the RF interface (carrier(s)) between an access terminal and the network via one or more transceivers. The HDR base station provides a separate data only (DO) carrier for HDR applications for each sector (or cell) served by the HDR base station. A separate base station or carrier (not shown) provides the voice carrier(s) for voice applications. A HDR access terminal may be a DO access terminal or a dual mode mobile terminal capable of utilizing both voice services and data services. To engage in a data session, the HDR access terminal connects to a DO carrier to use the DO high-speed data service. The data session is controlled by a Packet Data Service Node (PDSN) 111, which routes all data packets between the HDR access terminal and the Internet. The PDSN 111 has a direct connection to a Packet Control Function (PCF) 109, which interfaces with a Base Station Controller (BSC) of the HDR base station. The BSC is responsible for operation, maintenance and administration of the HDR base station, speech coding, rate adaptation and handling of the radio resources. It should be understood that the BSC may be a separate node or may be co-located with one or more HDR base stations.

Each HDR base station can serve multiple (e.g., three) sectors (or cells). However, it should be understood that each HDR base station may serve only a single cell (referred to as an omni cell). It should also be understood that the network may include multiple HDR base stations, each serving one or more sectors, with HDR mobile terminals being capable of handing off between sectors of the same HDR base station or sectors of different HDR base stations. For each sector (or cell), the HDR base station further employs a single shared, time division multiplexed (TDM) forward link, where only a single HDR mobile terminal is served at any instance. The forward link throughput rate is shared by all HDR mobile terminals. A HDR access terminal selects a serving sector (or cell) of the HDR base station by pointing its Data Rate Control (DRC) towards the sector and requesting a forward data rate according to the channel conditions (i.e., based on the Carrier to Interference (C/I) ratio of the channel).

As shown, the AN 105 communicates with a Packet Data Service Node (PDSN) 111 via a Packet Control Function (PCF) 109. Either the AN 105 or the PCF 109 provides a SC/MM (Session Control and Mobility Management) function, which among other functions includes storing of HRPD session related information, performing the terminal authentication procedure to determine whether an AT 101 should be authenticated when the AT 101 is accessing the radio network, and managing the location of the AT 101. The PCF 109 is further described in 3GPP2 A.S0001-A v2.0, entitled “3GPP2 Access Network Interfaces Interoperability Specification,” June 2001, which is incorporated herein by reference in its entirety. Also, a more detailed description of the HRPD is provided in TSG-C.S0024-IS-856, entitled “cdma2000 High Rate Packet Data Air Interface Specification,” which is incorporated herein by reference in its entirety.

The wireless communication system (e.g., system 100) may be designed to provide various types of services. These services may include point-to-point services, or dedicated services such as voice and packet data, whereby data is transmitted from a transmission source (e.g., a base station) to a specific recipient terminal. Such services may also include point-to-multipoint (i.e., multicast) services, or broadcast services, whereby data is transmitted from a transmission source to a number of recipient terminals.

In the multiple-access wireless communication system 100, communications between users are conducted through one or more AT(s) 101 and a user (access terminal) on one wireless station communicates to a second user on a second wireless station by conveying information signal on a reverse link to a base station. The AN 105 receives the information signal and conveys the information signal on a forward link to the AT station 101. The AN 105 then conveys the information signal on a forward link to the station 101. The forward link refers to transmissions from an AN 105 to a wireless station 101, and the reverse link refers to transmissions from the station 101 to the AN 105. The AN 105 receives the data from the first user on the wireless station on a reverse link, and routes the data through a public switched telephone network (PSTN) to the second user on a landline station. In many communication systems, e.g., IS-95, Wideband CDMA (WCDMA), and IS-2000, the forward link and the reverse link are allocated separate frequencies.

In one embodiment, the system of FIG. 1 supports an asymmetric combination of “N” carriers on the forward link, and “M” carriers on the reverse link, wherein N and M represent integers. However, there is a need to address the manner in which control channel monitoring can be performed when N forward traffic channels are aggregated. The invention, according to various exemplary embodiments, addresses, among other issues, the issue of how control channel monitoring is performed.

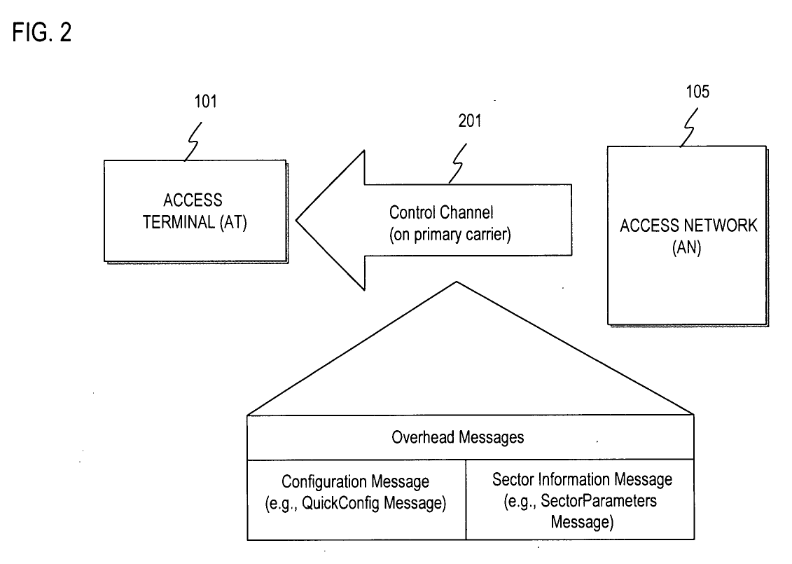

FIG. 2 is a diagram an AN and an AT utilizing a primary channel for exchanging overhead messages, in accordance with an embodiment of the invention. The invention, according to one embodiment, designates one carrier (“primary” carrier) 107 among multiple carriers 103a for performing control channel supervision. In an exemplary embodiment, the single carrier provides exchange of overhead messages, which can include a configuration message to indicate a change in the content of the overhead messages and to specify frequently changing information, or a sector information (or parameter) message for conveying sector specific information to an AT 101.

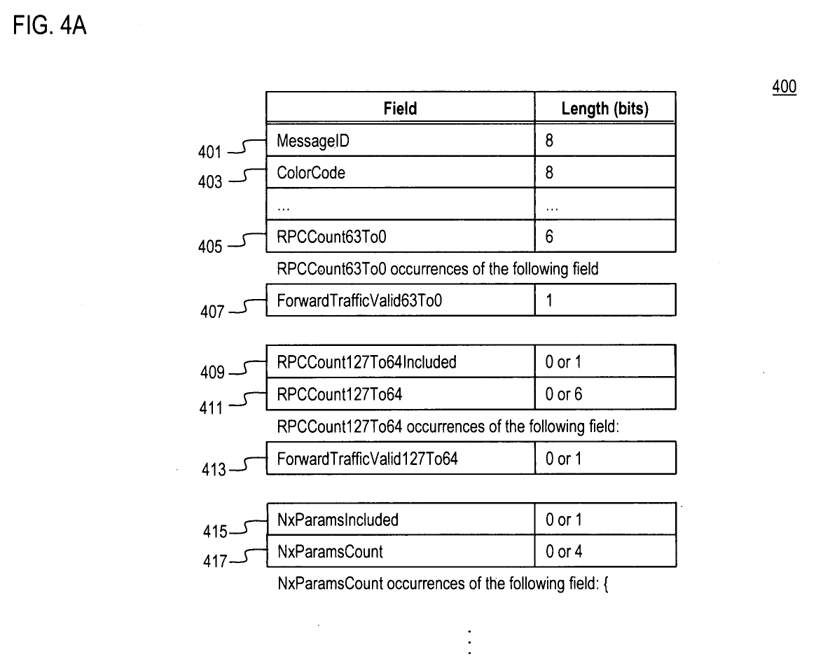

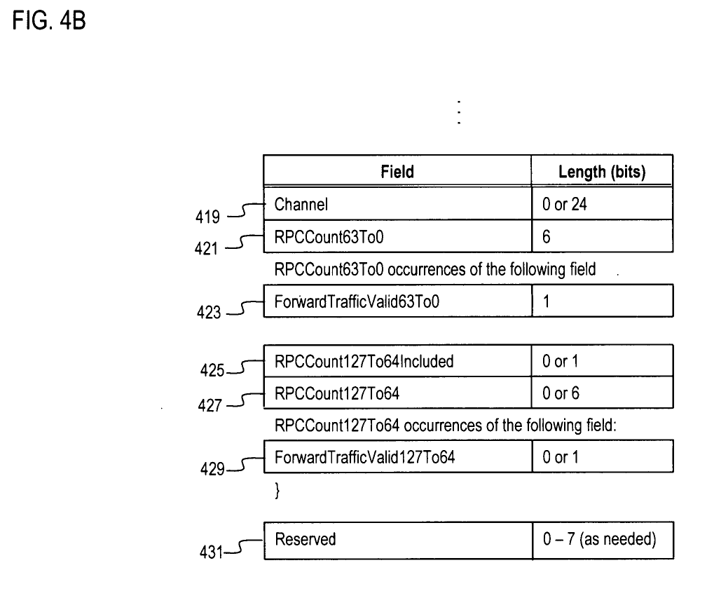

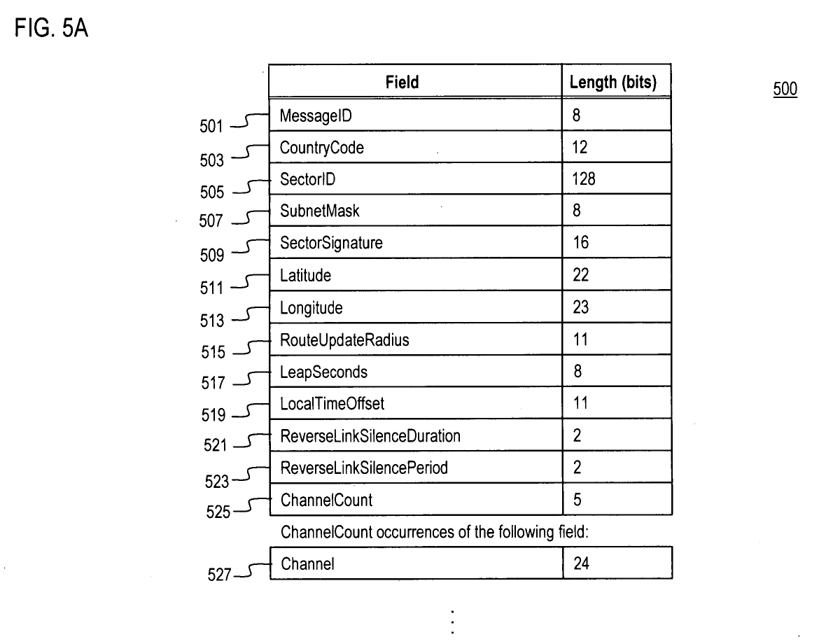

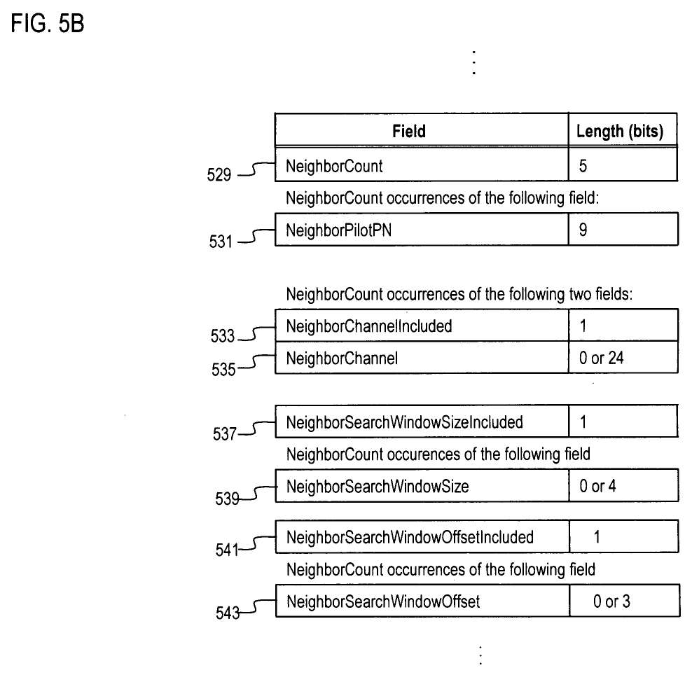

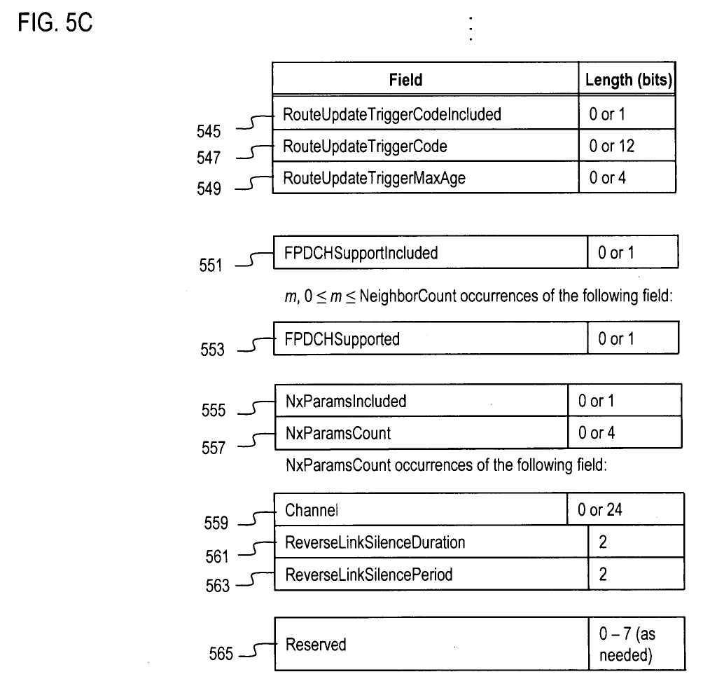

By way of example, the AT 101 monitors the control channel 201 for the following information: forward traffic channel supervision (FTC Valid bit); and reverse link silence period. The approach optimizes the usage of control channel 201 when an AT 101 is in the connected state, with more than one channels (or carriers) used for traffic channel. In the 3GPP2 HRPD architecture, the configuration message can be a QuickConfig message, and the sector information message can be a SectorParameters message. These overhead messages are more detailed in FIGS. 4 and 5.

The process of FIG. 2 involves providing the access terminal 101 can perform supervision on the channel control messages, e.g., QuickConfig and SectorParameters messages. The QuickConfig message and the SectorParameters message are collectively termed the overhead messages. These messages, in one embodiment, are broadcast by the access network over the control channel 201. These messages pertain to multiple protocols and are, therefore, specified separately.

The Overhead Messages Protocol provides procedures related to transmission, reception and supervision of the overhead messages. This protocol can be in one of two states: (1) Inactive State, and (2) Active State. In the Inactive State, the protocol waits for an Activate command. This state corresponds only to the access terminal and occurs when the access terminal has not acquired an access network 105 or is not required to receive overhead messages. In the Active state, the access network 105 transmits and the access terminal 101 receives overhead messages.

The overhead messages and the Overhead Messages Protocol are further detailed in the 3GPP2 C.S0024-A CDMA2000, entitled “High Rate Packet Data Air Interface Specification”; and C25-20050314-003R2 Multi-Carrier HRPD Stage 2, the entireties of which are incorporated herein by reference. However, unlike the process of FIG. 2, these standards do not provide for use of a primary carrier in monitoring of the control channel 201.

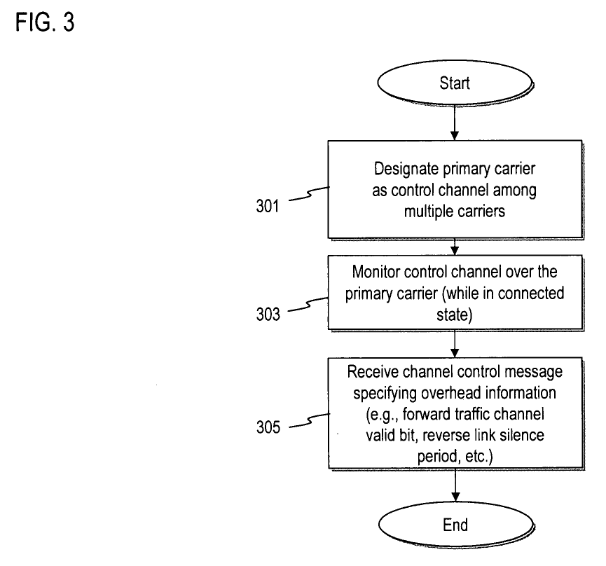

FIG. 3 is a flowchart of exemplary process for performing control channel supervision using a primary carrier, according to various embodiments of the invention. This exemplary process involves designating one of the N multiple carriers as a primary carrier for the control channel, per step 301. In step 303, the access terminal 101 monitors the control channel over the designated primary carrier, while in the connected state. The access terminal 101, as in step 305, receives control channel messages. As mentioned, these overhead messages can specify, for example, whether a particular forward traffic channel is valid, the reverse link silence period, etc. In an exemplary embodiment, information about the forward traffic channel can be sent within a configuration message—e.g., QuickConfig message, and the reverse link silence period can be specified in a sector parameter message (e.g., SectorParameters message).

By way of example, a QuickConfig message and SectorParameters message as shown in FIGS. 4 and 5 respectively can be used to monitor traffic channel when multiple forward traffic channels are aggregated.

FIGS. 4A-4B, according to various embodiments of the invention, describe an exemplary format of the quick configuration message (denoted as “QuickConfig message”). The QuickConfig message is used to indicate content changes within the overhead messages. The QuickConfig message is used to indicate a change in the overhead messages' contents and to provide frequently changing information. Table 1 enumerates exemplary fields in the QuickConfig message.

TABLE 1

| RADIO LINK PROTOCOL | |
|---|---|
| ELEMENTS (FIELD) | DESCRIPTION |
| MessageID 401 | The access network 105 sets this field to |
| | 0x00. |
| ColorCode 403 | The access network 105 sets this field to the color code |
| | corresponding to this sector. |
| SectorID24 | The access network 105 can set this field to the least |
| | significant 24 bits of the SectorID |
| | value corresponding to this sector. |
| SectorSignature | The access network 105 can set this field to |
| | the value of the SectorSignature field of the |
| | next SectorParameters message it will |
| | transmit. |
| AccessSignature | The access network 105 can set this field to |
| | the value of the AccessSignature parameter |
| | from the AccessParameters message that is |
| | Public Data of the Access Channel MAC |
| | Protocol. |
| Redirect | Access network redirect. The access |
| | network can set this field to ‘1’ if it is |
| | redirecting all access terminals away from |
| | this access network. |
| RPCCount63To0 405 | The access network 105 sets this field to the |
| | maximum number of Reverse Power |
| | Control (RPC) channels supported by the |
| | sector corresponding to forward traffic |
| | channels associated with MAC indices 0 |
| | through 63, inclusive. |
| ForwardTrafficValid63To0 407 | The access network 105 sets occurrence n of |
| | this field to ‘1’ if the forward traffic channel |
| | associated with MACIndex 64−n is valid. |
| | The access terminal 101 uses this field to |
| | perform supervision of the forward traffic |
| | channel. |
| RPCCount127To64Included 409 | If this field is included, the access network |
| | 105 sets this field to ‘1’ if the |
| | RPCCount127To64 field is included in this |
| | message. Otherwise, the access network 105 |
| | sets this field to ‘0’. |
| RPCCount127To64 411 | If the RPCCount127To64Included field is |
| | omitted, or if RPCCount127To64Included is |
| | ‘0’, then the access network 105 omits this |
| | field. Otherwise, the access network 105 |
| | sets this field to the maximum number of |
| | RPC channels supported by the sector |
| | corresponding to forward traffic channels |
| | associated with MAC indices 64 through |
| | 127, inclusive. |
| ForwardTrafficValid127To64 413 | If the RPCCount127To64Included field is |
| | omitted, or if RPCCount127To64Included is |
| | ‘0’, then the access network 105 omits this |
| | field. Otherwise, the access network 105 |
| | sets occurrence n of this field to ‘1’ if the |
| | forward traffic channel associated with |
| | MACIndex 128−n is valid. The access |
| | terminal 101 uses this field to perform |
| | supervision of the forward traffic channel. |
| NxParamsIncluded 415 | If this field is included, the access network |
| | 105 sets this field as follows: If Nx |
| | Parameters are included in this message, |
| | then the access network 105 sets this field to |
| | ‘1’, otherwise the access network 105 sets |
| | this field to ‘0’. |
| NxParamsCount 417 | If the NxParamsIncluded field is set to ‘0’, |
| | or is not included, the access network 105 |
| | omits this field. Otherwise, the access |
| | network 105 sets this field to the number of |
| | Nx carriers. |
| Channel 419 | If the NxParamsIncluded field is set to ‘0’, |
| | or is not included, the access network 105 |
| | omits this field. Otherwise, the access |
| | network 105 sets this field to the channel in |
| | the Nxcarriers. |
| RPCCount63To0 421 | The access network 105 sets this field to the |
| | maximum number of RPC channels |
| | supported by the sector corresponding to |
| | forward traffic channels associated with |
| | MAC indices 0 through 63, inclusive. |
| ForwardTrafficValid63To0 423 | The access network 105 sets occurrence n of |
| | this field to ‘1’ if the forward traffic channel |
| | associated with MACIndex 64−n is valid. |
| | The access terminal 101 uses this field to |
| | perform supervision of the forward traffic |
| | channel. |
| RPCCount127To64Included 425 | If this field is included, the access network |
| | 105 sets this field to ‘1’ if the |
| | RPCCount127To64 field is included in this |
| | message. Otherwise, the access network 105 |
| | sets this field to ‘0’. |
| RPCCount127To64 427 | If the RPCCount127To64Included field is |
| | omitted, or if RPCCount127To64Included is |
| | ‘0’, then the access network 105 omits this |
| | field. Otherwise, the access network 105 |
| | sets this field to the maximum number of |
| | RPC channels supported by the sector |
| | corresponding to forward traffic channels |
| | associated with MAC indices 64 through |
| | 127, inclusive. |
| ForwardTrafficValid127To64 429 | If the RPCCount127To64Included field is |
| | omitted, or if RPCCount127To64Included is |
| | ‘0’, then the access network 105 omits this |
| | field. Otherwise, the access network 105 |
| | sets occurrence n of this field to ‘1’ if the |
| | forward traffic channel associated with |
| | MACIndex 128−n is valid. The access |
| | terminal 101 uses this field to perform |
| | supervision of the forward traffic channel. |
| Reserved 431 | The number of bits in this field is equal to |
| | the number needed to make the message |
| | length an integer number of octets. |

As indicated the fields in Table 1 for the QuickConfig message are exemplary in nature, and can include other fields. For instance, Table 2 specifies other fields (not shown in FIGS. 4A and 4B) that can be included:

TABLE 2

| RADIO LINK PROTOCOL | |
|---|---|
| ELEMENTS (FIELD) | DESCRIPTION |
| SectorID24 | The access network 105 can set this field to |
| | the least significant 24 bits of the SectorID |
| | value corresponding to this sector. |
| SectorSignature | The access network 105 can set this field to |
| | the value of the SectorSignature field of the |
| | next SectorParameters message it will |
| | transmit. |
| AccessSignature | The access network 105 can set this field to |
| | the value of the AccessSignature parameter |
| | from the AccessParameters message that is |
| | Public Data of the Access Channel MAC |
| | Protocol. |
| Redirect | Access network redirect. The access |
| | network can set this field to ‘1’ if it is |
| | redirecting all access terminals away from |
| | this access network. |

For example, the access network 105 includes a QuickConfig message in every control channel synchronous capsule. The access network 105 can include a SectorParameters message in the synchronous capsule at least once every N_{OMPSectorParameters} control channel cycles. The access network 105 sets the SectorSignature field of the QuickConfig message to the SectorSignature field of the next SectorParameters message. The access network 105 sets the AccessSignature field of the QuickConfig message to the public data AccessSignature.

When the access terminal 101 receives the QuickConfig message, it performs the following procedure. If the value of the SectorSignature field of the new QuickConfig message is different from the stored value for SectorSignature, the access terminal 101 notes the condition. The access terminal 101 monitors every subsequent control channel synchronous capsule until it receives the updated SectorParameters message. Once the access terminal 101 receives an updated overhead message, the terminal 101 stores the signature associated with the message for future comparisons. The access terminal 101 may cache overhead message parameters and signatures to speed up acquisition of parameters from a sector that was previously monitored.

Upon entering the Active State, the access terminal 101 starts the following procedure to supervise the QuickConfig message. The access terminal 101 sets a QuickConfig supervision timer for T_{OMPQCSupervision}. (Overhead Message Protocol QuickConfig). If a QuickConfig message is received while the timer is active, the access terminal 101 resets and restarts the timer. If the timer expires, the access terminal 101 returns a SupervisionFailed indication and disables the timer.

Additionally, in the Active State, the access terminal 101 monitors the SectorParameters message, setting a SectorParameters supervision timer for T_{OMPQCSupervision}. If a SectorParameters message is received while the timer is active, the access terminal 101 resets and restarts the timer. If the timer expires, the access terminal 101 returns a SupervisionFailed indication and disables the timer.

Table 3 enumerates exemplary fields in the sector parameters message.

TABLE 3

| RADIO LINK PROTOCOL | |
|---|---|
| ELEMENTS (FIELD) | DESCRIPTION |
| MessageID 501 | The access network 105 sets this field |
| | to 0x01. |
| CountryCode 503 | The access network 105 can set this |
| | field to the three-digit BCD (binary |
| | coded decimal) encoded representation |
| | of the Mobile Country Code associated |
| | with this sector. |
| SectorID 505 | Sector Address Identifier. The access |
| | network 105 sets this field to the 128- |
| | bit address of this sector. |
| SubnetMask 507 | Sector Subnet identifier. The access |
| | network 105 sets this field to the |
| | number of consecutive 1's in the subnet |
| | mask of the subnet to which this sector |
| | belongs. |
| SectorSignature 509 | SectorParameters message signature. |
| | The access network 105 changes this |
| | field if the contents of the |
| | SectorParameters message changes. |
| Latitude 511 | The latitude of the sector. The access |
| | network 105 sets this field to its |
| | latitude in units of 0.25 second, |
| | expressed as a two's complement |
| | signed number with positive numbers |
| | signifying North latitudes. The access |
| | network 105 sets this field to a value in |
| | the range −1296000 to 1296000 |
| | inclusive (corresponding to a range of −90° |
| | to +90°). |
| Longitude 513 | The longitude of the sector. The access |
| | network 105 sets this field to its |
| | longitude in units of 0.25 second, |
| | expressed as a two's complement |
| | signed number with positive numbers |
| | signifying East longitude. The access |
| | network 105 sets this field to a value in |
| | the range −2592000 to 2592000 |
| | inclusive (corresponding to a range of −180° |
| | to +180°). |
| RouteUpdateRadiusOverhead 515 | If access terminals 101 are to perform |
| | distance based route updates, the access |
| | network 105 sets this field to the non- |
| | zero “distance” beyond which the |
| | access terminal 101 is to send a new |
| | RouteUpdate message. If access |
| | terminals 101 are not to perform |
| | distance based route updates, the access |
| | network 105 sets this field to 0. Note: |
| | a RouteUpdate message notifies the |
| | access network 105 of the current |
| | location of the access terminal 101 and |
| | provides the access network 105 with |
| | an estimate of the surrounding radio |
| | link conditions. |
| LeapSeconds 517 | The number of leap seconds that have |
| | occurred since the start of system time. |
| LocalTimeOffset 519 | The access network 105 sets this field |
| | to the offset of the local time from |
| | System Time. This value is in units of |
| | minutes, expressed as a two's |
| | complement signed number. |
| ReverseLinkSilenceDuration 521 | The access network 105 sets this field |
| | to specify the duration of the Reverse |
| | Link Silence Interval in units of frames. |
| ReverseLinkSilencePeriod 523 | The access network 105 sets this field |
| | to specify the period of the Reverse |
| | Link Silence Interval. The Reverse |
| | Link Silence Interval is defined as the |
| | time interval of duration |
| | ReverseLinkSilenceDuration frames |
| | that starts at times T where T is the |
| | CDMA System Time in units of frames |
| | and it satisfies the following equation: |
| | T mod (2048×2^{ReverseLinkSilencePeriod} − 1) = 0. |
| ChannelCount 525 | The access network 105 sets this field |
| | to the number of cdma2000 high rate |
| | packet data channels available to the |
| | access terminal 101 on this sector. |
| Channel 527 | Channel record specification for each |
| | 1xEV-DO channel. The access |
| | network 105 sets the SystemType field |
| | of this record to 0x00. |
| NeighborCount 529 | The access network 105 sets this field |
| | to the number of records specifying |
| | neighboring sectors information |
| | included in this message. |
| NeighborPilotPN 531 | The access network 105 can set this |
| | filed to the Pseudo-Noise (PN) Offset |
| | of a neighboring sector that the access |
| | terminal 101 should add to its Neighbor |
| | Set. |
| NeighborChannelIncluded 533 | The access network 105 sets this field |
| | to 1, if a Channel record is included for |
| | this neighbor, and to ‘0’ otherwise. |
| | The nth occurrence of this field |
| | corresponds to the nth occurrence of |
| | NeighborPilotPN in the record that |
| | contains the NeighborPilotPN field |
| | above. |
| NeighborChannel 535 | Channel record specification for the |
| | neighbor channel. The access network |
| | 105 omits this field if the |
| | corresponding |
| | NeighborChannelIncluded field is set to |
| | ‘0’. Otherwise, if included, the nth |
| | occurrence of this field corresponds to |
| | the nth occurrence of NeighborPilotPN |
| | in the record that contains the |
| | NeighborPilotPN field above. |
| NeighborSearch WindowSizeIncluded | The access network 105 sets this field |
| 537 | to ‘1’ if NeighborSeachWindowSize |
| | field for neighboring sectors is included |
| | in this message. Otherwise, the access |
| | network 105 sets this field to ‘0’. |
| NeighborSearchWindowSize 539 | The access network 105 omits this field |
| | if NeighborSearchWindowSizeIncluded |
| | is set to ‘0’. |
| | If |
| | NeighborSearchWindowSizeIncluded |
| | is set to ‘1’, the access network 105 |
| | sets this field to a predetermined value |
| | corresponding to the search window |
| | size to be used by the access terminal |
| | 101 for the neighbor pilot. The nth |
| | occurrence of this field corresponds to |
| | the nth occurrence of NeighborPilotPN |
| | in the record that contains the |
| | NeighborPilotPN field above. |
| NeighborSearchWindowOffsetIncluded | The access network 105 sets this field |
| 541 | to ‘1’ if NeighborSeachWindowOffset |
| | field for neighboring sectors is included |
| | in this message. Otherwise, the access |
| | network 105 sets this field to ‘0’. |
| NeighborSeachWindowOffset 543 | The access network 105 omits this field |
| | if |
| | NeighborSearchWindowOffsetIncluded |
| | is set to ‘0’. |
| | If |
| | NeighborSearchWindowOffsetIncluded |
| | is set to ‘1’, the access network 105 |
| | sets this field to a predetermined value. |
| | Corresponding to the search window |
| | offset to be used by the access terminal |
| | 101 for the neighbor pilot. The nth |
| | occurrence of this field corresponds to |
| | the nth occurrence of NeighborPilotPN |
| | in the record that contains the |
| | NeighborPilotPN field above. |
| RouteUpdateTriggerCodeIncluded 545 | The access network 105 includes this |
| | field if any of the fields other than the |
| | Reserved field that follow this field are |
| | to be included in the message. If this |
| | field is included, the access network |
| | 105 can set it as follows: The access |
| | network 105 can set this field to ‘1’ if |
| | RouteUpdateTriggerCode is included |
| | in this message. Otherwise, the access |
| | network 105 can set this field to ‘0’. If |
| | this field is not included in the |
| | message, that access terminal 101 |
| | assumes a value of ‘0’ for this field. |
| RouteUpdateTriggerCode 547 | If the |
| | RouteUpdateTriggerCodeIncluded field |
| | is not included in this message, or if the |
| | RouteUpdateTriggerCodeIncluded field |
| | is included and is set to ‘0’, then the |
| | access network 105 can omit this field. |
| | Otherwise, the access network 105 can |
| | set this field to a 12-bit value. |
| RouteUpdateTriggerMaxAge 549 | If the |
| | RouteUpdateTriggerCodeIncluded field |
| | is not included in this message or if the |
| | RouteUpdateTriggerCodeIncluded field |
| | is included and set to ‘0’, the access |
| | network can omit this field. Otherwise, |
| | the access network 105 can set this |
| | field to indicate the duration of the |
| | RouteUpdateTriggerCode timer. |
| FPDCHSupportIncluded 551 | The access network 105 includes this |
| | field if any of the fields other than the |
| | Reserved field that follow this field are |
| | to be included in the message. If this |
| | field is not included in the message, the |
| | access terminal assumes a value of ‘0’ |
| | for this field. If this field is included, |
| | the access network 105 can set this |
| | field as follows: The access network |
| | 105 can set this field to ‘0’ if the |
| | FPDCHSupported fields are omitted. |
| | Otherwise, the access network 105 can |
| | set this field to ‘1’. |
| FPDCHSupport 553 | If FPDCHSupportedIncluded is not |
| | included or is included and is set to ‘0’, |
| | then the access network 105 can omit |
| | all occurrences of this field. Otherwise, |
| | the access network 105 includes m |
| | occurrences of this field, where m is the |
| | number of NeighborChannel records in |
| | this message that have SystemType |
| | equal to 0x01, and the access network |
| | 105 can set the occurrences of this field |
| | as follows: The access network 105 can |
| | set the ith occurrence of this field as |
| | follows: If the system on the CDMA |
| | channel corresponding to the ith |
| | NeighborChannel record that has |
| | SystemType equal to 0x01 supports the |
| | Forward Packet Data Channel, the |
| | access network 105 can set the ith |
| | occurrence of this field to ‘1’. |
| | Otherwise, the access network 105 can |
| | set the ith occurrence of this field to |
| | ‘0’. |
| NxParamsIncluded 555 | If this field is included, the access |
| | network 105 sets this field as follows: |
| | If Nx Parameters are included in this |
| | message, then the access network 105 |
| | sets this field to ‘1’, otherwise the |
| | access network 105 sets this field to |
| | ‘0’. |
| NxParamsCount 557 | If the NxParamsIncluded field is set to |
| | ‘0’, or is not included, the access |
| | network 105 omits this field. |
| | Otherwise, the access network 105 sets |
| | this field to the number of Nx carriers |
| Channel 559 | If the NxParamsIncluded field is set to |
| | ‘0’, or is not included, the access |
| | network 105 omits this field. |
| | Otherwise, the access network 105 sets |
| | this field to the channel in the |
| | Nxcarriers |
| ReverseLinkSilenceDuration 561 | The access network 105 sets this field |
| | to specify the duration of the Reverse |
| | Link Silence Interval in units of frames |
| | for the specified Channel 559. |
| ReverseLinkSilence Period 563 | The access network 105 sets this field |
| | to specify the period of the Reverse |
| | Link Silence Interval for the specified |
| | Channel 559. |
| Reserved 565 | The number of bits in this field is equal |
| | to the number needed to make the |
| | message length an integer number of |
| | octets. The access network 105 sets this |
| | field to zero. The access terminal 101 |
| | ignores this field. |

The access terminal 101 conforms to the following rules when sending a probe. The access terminal 101 verifies that the last Overhead messages Protocol SectorParameters message it received is current, according to the last QuickConfig message transmitted by the access network 105 prior to sending the first probe of the first probe sequence.

The access terminal 101 monitors every subsequent control channel synchronous capsule until it receives the updated SectorParameters message. As explained, the SectorParameters message is used to convey sector specific information to the access terminals 101. The access terminal 101 verifies that the last Overhead Messages Protocol SectorParameters message it received is current, according to the last QuickConfig message transmitted by the access network 105 prior to sending the first probe of the first probe sequence.

It is recognized that the message formats of FIGS. 4A and 4B and 5A-5C are exemplary in nature, and can be organized in numerous ways and can utilize other information formats to monitor multiple traffic channels.

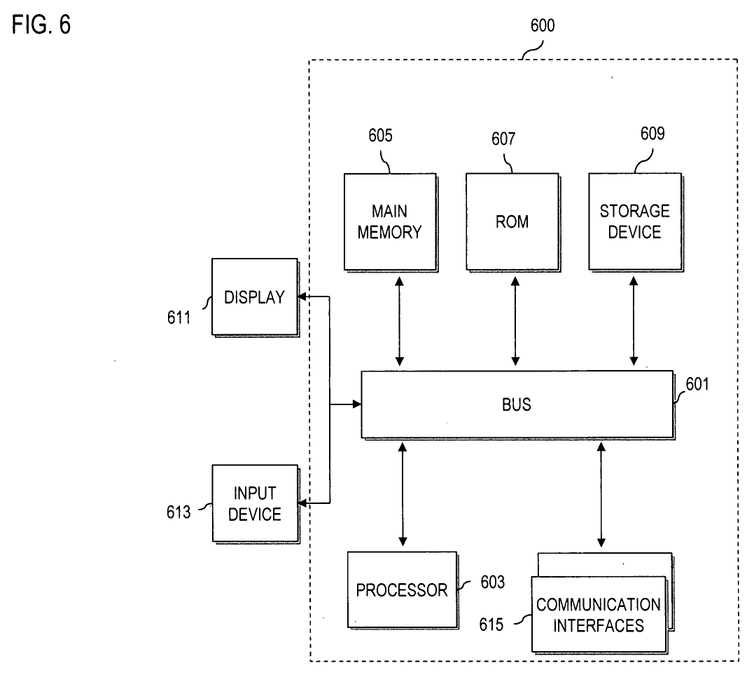

One of ordinary skill in the art would recognize that the processes for performing control channel monitoring may be implemented via software, hardware (e.g., general processor, Digital Signal Processing (DSP) chip, an Application Specific Integrated Circuit (ASIC), Field Programmable Gate Arrays (FPGAs), etc.), firmware, or a combination thereof. Such exemplary hardware for performing the described functions is detailed below with respect to FIG. 6.

FIG. 6 illustrates exemplary hardware upon which various embodiments of the invention can be implemented. A computing system 600 includes a bus 601 or other communication mechanism for communicating information and a processor 603 coupled to the bus 601 for processing information. The computing system 600 also includes main memory 605, such as a random access memory (RAM) or other dynamic storage device, coupled to the bus 601 for storing information and instructions to be executed by the processor 603. Main memory 605 can also be used for storing temporary variables or other intermediate information during execution of instructions by the processor 603. The computing system 600 may further include a read only memory (ROM) 607 or other static storage device coupled to the bus 601 for storing static information and instructions for the processor 603. A storage device 609, such as a magnetic disk or optical disk, is coupled to the bus 601 for persistently storing information and instructions.

The computing system 600 may be coupled via the bus 601 to a display 611, such as a liquid crystal display, or active matrix display, for displaying information to a user. An input device 613, such as a keyboard including alphanumeric and other keys, may be coupled to the bus 601 for communicating information and command selections to the processor 603. The input device 613 can include a cursor control, such as a mouse, a trackball, or cursor direction keys, for communicating direction information and command selections to the processor 603 and for controlling cursor movement on the display 611.

According to various embodiments of the invention, the processes described herein can be provided by the computing system 600 in response to the processor 603 executing an arrangement of instructions contained in main memory 605. Such instructions can be read into main memory 605 from another computer-readable medium, such as the storage device 609. Execution of the arrangement of instructions contained in main memory 605 causes the processor 603 to perform the process steps described herein. One or more processors in a multi-processing arrangement may also be employed to execute the instructions contained in main memory 605. In alternative embodiments, hard-wired circuitry may be used in place of or in combination with software instructions to implement the embodiment of the invention. In another example, reconfigurable hardware such as Field Programmable Gate Arrays (FPGAs) can be used, in which the functionality and connection topology of its logic gates are customizable at run-time, typically by programming memory look up tables. Thus, embodiments of the invention are not limited to any specific combination of hardware circuitry and software.

The computing system 600 also includes at least one communication interface 615 coupled to bus 601. The communication interface 615 provides a two-way data communication coupling to a network link (not shown). The communication interface 615 sends and receives electrical, electromagnetic, or optical signals that carry digital data streams representing various types of information. Further, the communication interface 615 can include peripheral interface devices, such as a Universal Serial Bus (USB) interface, a PCMCIA (Personal Computer Memory Card International Association) interface, etc.

The processor 603 may execute the transmitted code while being received and/or store the code in the storage device 609, or other non-volatile storage for later execution. In this manner, the computing system 600 may obtain application code in the form of a carrier wave.

The term “computer-readable medium” as used herein refers to any medium that participates in providing instructions to the processor 603 for execution. Such a medium may take many forms, including but not limited to non-volatile media, volatile media, and transmission media. Non-volatile media include, for example, optical or magnetic disks, such as the storage device 609. Volatile media include dynamic memory, such as main memory 605. Transmission media include coaxial cables, copper wire and fiber optics, including the wires that comprise the bus 601. Transmission media can also take the form of acoustic, optical, or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media may be involved in providing instructions to a processor for execution. For example, the instructions for carrying out at least part of the invention may initially be borne on a magnetic disk of a remote computer. In such a scenario, the remote computer loads the instructions into main memory and sends the instructions over a telephone line using a modem. A modem of a local system receives the data on the telephone line and uses an infrared transmitter to convert the data to an infrared signal and transmit the infrared signal to a portable computing device, such as a personal digital assistant (PDA) or a laptop. An infrared detector on the portable computing device receives the information and instructions borne by the infrared signal and places the data on a bus. The bus conveys the data to main memory, from which a processor retrieves and executes the instructions. The instructions received by main memory can optionally be stored on storage device either before or after execution by processor.

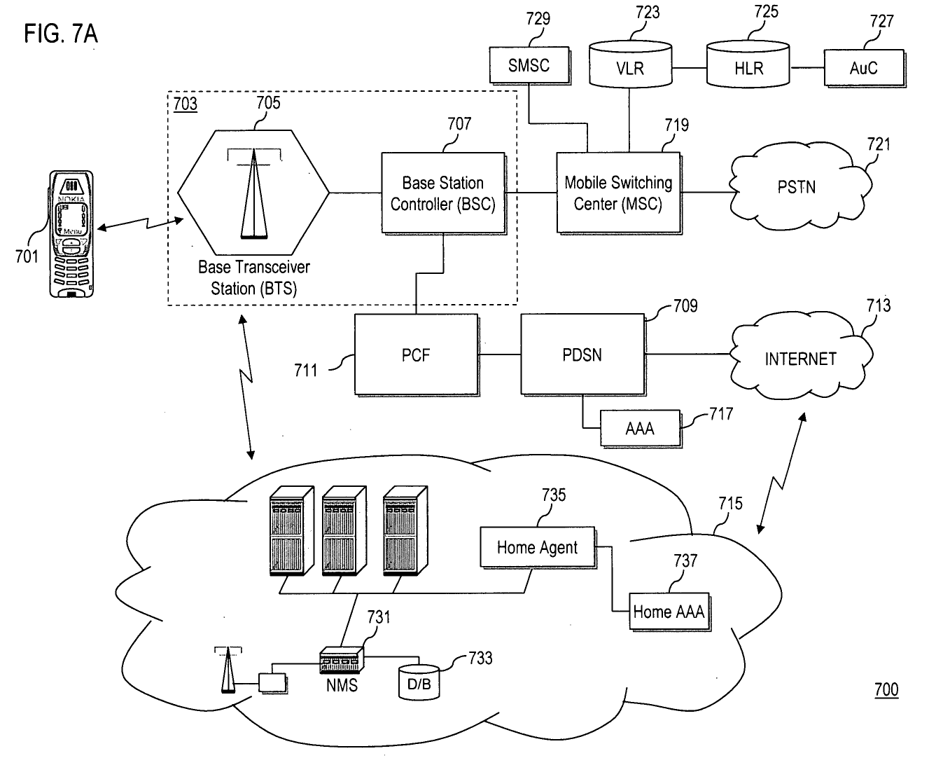

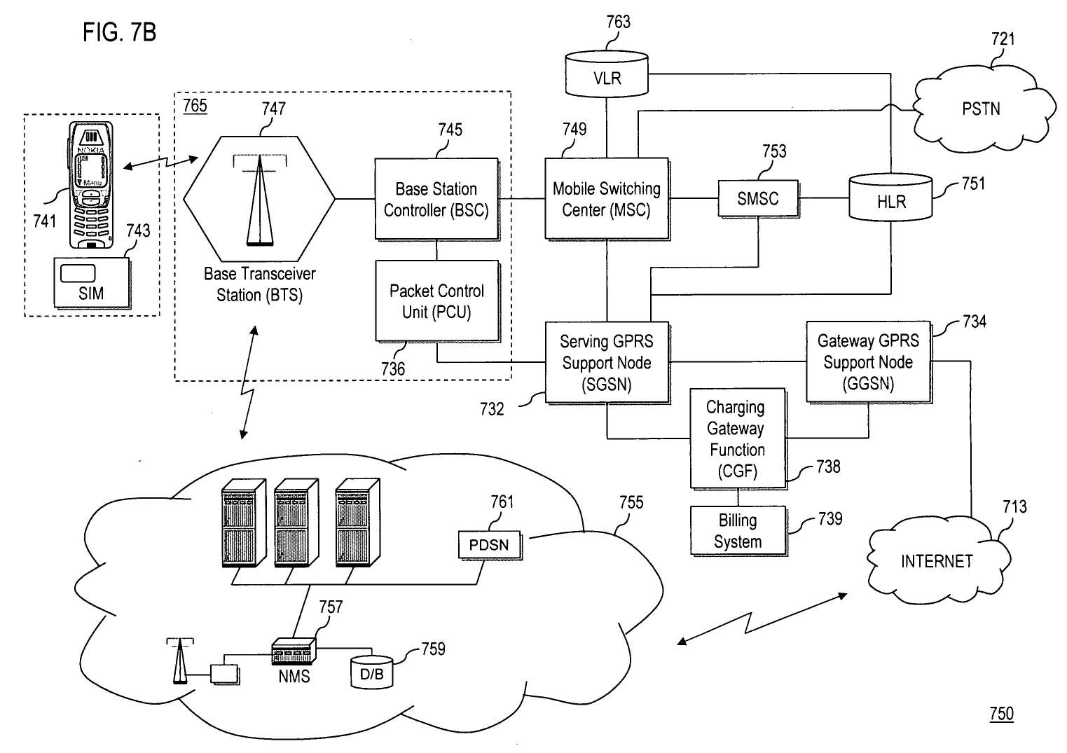

FIGS. 7A and 7B are diagrams of different cellular mobile phone systems capable of supporting various embodiments of the invention. FIGS. 7A and 7B show exemplary cellular mobile phone systems each with both mobile station (e.g., handset) and base station having a transceiver installed (as part of a Digital Signal Processor (DSP)), hardware, software, an integrated circuit, and/or a semiconductor device in the base station and mobile station). By way of example, the radio network supports Second and Third Generation (2G and 3G) services as defined by the International Telecommunications Union (ITU) for International Mobile Telecommunications 2000 (IMT-2000). For the purposes of explanation, the carrier and channel selection capability of the radio network is explained with respect to a cdma2000 architecture. As the third-generation version of IS-95, cdma2000 is being standardized in the Third Generation Partnership Project 2 (3GPP2).

A radio network 700 includes mobile stations 701 (e.g., handsets, terminals, stations, units, devices, or any type of interface to the user (such as “wearable” circuitry, etc.)) in communication with a Base Station Subsystem (BSS) 703. According to one embodiment of the invention, the radio network supports Third Generation (3G) services as defined by the International Telecommunications Union (ITU) for International Mobile Telecommunications 2000 (IMT-2000).

In this example, the BSS 703 includes a Base Transceiver Station (BTS) 705 and Base Station Controller (BSC) 707. Although a single BTS is shown, it is recognized that multiple BTSs are typically connected to the BSC through, for example, point-to-point links. Each BSS 703 is linked to a Packet Data Serving Node (PDSN) 709 through a transmission control entity, or a Packet Control Function (PCF) 711. Since the PDSN 709 serves as a gateway to external networks, e.g., the Internet 713 or other private consumer networks 715, the PDSN 709 can include an Access, Authorization and Accounting system (AAA) 717 to securely determine the identity and privileges of a user and to track each user's activities. The network 715 comprises a Network Management System (NMS) 731 linked to one or more databases 733 that are accessed through a Home Agent (HA) 735 secured by a Home AAA 737.

Although a single BSS 703 is shown, it is recognized that multiple BSSs 703 are typically connected to a Mobile Switching Center (MSC) 719. The MSC 719 provides connectivity to a circuit-switched telephone network, such as the Public Switched Telephone Network (PSTN) 721. Similarly, it is also recognized that the MSC 719 may be connected to other MSCs 719 on the same network 700 and/or to other radio networks. The MSC 719 is generally collocated with a Visitor Location Register (VLR) 723 database that holds temporary information about active subscribers to that MSC 719. The data within the VLR 723 database is to a large extent a copy of the Home Location Register (HLR) 725 database, which stores detailed subscriber service subscription information. In some implementations, the HLR 725 and VLR 723 are the same physical database; however, the HLR 725 can be located at a remote location accessed through, for example, a Signaling System Number 7 (SS7) network. An Authentication Center (AuC) 727 containing subscriber-specific authentication data, such as a secret authentication key, is associated with the HLR 725 for authenticating users. Furthermore, the MSC 719 is connected to a Short Message Service Center (SMSC) 729 that stores and forwards short messages to and from the radio network 700.

During typical operation of the cellular telephone system, BTSs 705 receive and demodulate sets of reverse-link signals from sets of mobile units 701 conducting telephone calls or other communications. Each reverse-link signal received by a given BTS 705 is processed within that station. The resulting data is forwarded to the BSC 707. The BSC 707 provides call resource allocation and mobility management functionality including the orchestration of soft handoffs between BTSs 705. The BSC 707 also routes the received data to the MSC 719, which in turn provides additional routing and/or switching for interface with the PSTN 721. The MSC 719 is also responsible for call setup, call termination, management of inter-MSC handover and supplementary services, and collecting, charging and accounting information. Similarly, the radio network 700 sends forward-link messages. The PSTN 721 interfaces with the MSC 719. The MSC 719 additionally interfaces with the BSC 707, which in turn communicates with the BTSs 705, which modulate and transmit sets of forward-link signals to the sets of mobile units 701.

As shown in FIG. 7B, the two key elements of the General Packet Radio Service (GPRS) infrastructure 750 are the Serving GPRS Supporting Node (SGSN) 732 and the Gateway GPRS Support Node (GGSN) 734. In addition, the GPRS infrastructure includes a Packet Control Unit (PCU) 736 and a Charging Gateway Function (CGF) 738 linked to a Billing System 739. A GPRS the Mobile Station (MS) 741 employs a Subscriber Identity Module (SIM) 743.

The PCU 736 is a logical network element responsible for GPRS-related functions such as air interface access control, packet scheduling on the air interface, and packet assembly and re-assembly. Generally the PCU 736 is physically integrated with the BSC 745; however, it can be collocated with a BTS 747 or a SGSN 732. The SGSN 732 provides equivalent functions as the MSC 749 including mobility management, security, and access control functions but in the packet-switched domain. Furthermore, the SGSN 732 has connectivity with the PCU 736 through, for example, a Fame Relay-based interface using the BSS GPRS protocol (BSSGP). Although only one SGSN is shown, it is recognized that that multiple SGSNs 732 can be employed and can divide the service area into corresponding routing areas (RAs). A SGSN/SGSN interface allows packet tunneling from old SGSNs to new SGSNs when an RA update takes place during an ongoing Personal Development Planning (PDP) context. While a given SGSN may serve multiple BSCs 745, any given BSC 745 generally interfaces with one SGSN 732. Also, the SGSN 732 is optionally connected with the HLR 751 through an SS7-based interface using GPRS enhanced Mobile Application Part (MAP) or with the MSC 749 through an SS7-based interface using Signaling Connection Control Part (SCCP). The SGSN/HLR interface allows the SGSN 732 to provide location updates to the HLR 751 and to retrieve GPRS-related subscription information within the SGSN service area. The SGSN/MSC interface enables coordination between circuit-switched services and packet data services such as paging a subscriber for a voice call. Finally, the SGSN 732 interfaces with a SMSC 753 to enable short messaging functionality over the network 750.

The GGSN 734 is the gateway to external packet data networks, such as the Internet 713 or other private customer networks 755. The network 755 comprises a Network Management System (NMS) 757 linked to one or more databases 759 accessed through a PDSN 761. The GGSN 734 assigns Internet Protocol (IP) addresses and can also authenticate users acting as a Remote Authentication Dial-In User Service host. Firewalls located at the GGSN 734 also perform a firewall function to restrict unauthorized traffic. Although only one GGSN 734 is shown, it is recognized that a given SGSN 732 may interface with one or more GGSNs 734 to allow user data to be tunneled between the two entities as well as to and from the network 750. When external data networks initialize sessions over the GPRS network 750, the GGSN 734 queries the HLR 751 for the SGSN 732 currently serving a MS 741.

The BTS 747 and BSC 745 manage the radio interface, including controlling which Mobile Station (MS) 741 has access to the radio channel at what time. These elements essentially relay messages between the MS 741 and SGSN 732. The SGSN 732 manages communications with an MS 741, sending and receiving data and keeping track of its location. The SGSN 732 also registers the MS 741, authenticates the MS 741, and encrypts data sent to the MS 741.

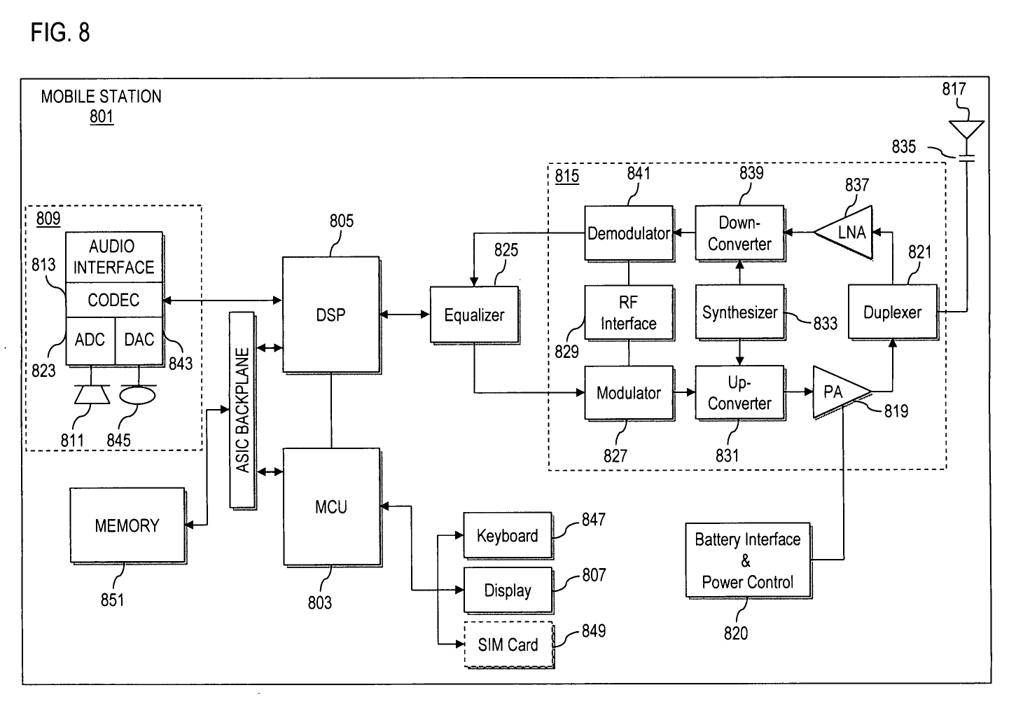

FIG. 8 is a diagram of exemplary components of a mobile station (e.g., handset) capable of operating in the systems of FIGS. 7A and 7B, according to an embodiment of the invention. Generally, a radio receiver is often defined in terms of front-end and back-end characteristics. The front-end of the receiver encompasses all of the Radio Frequency (RF) circuitry whereas the back-end encompasses all of the base-band processing circuitry. Pertinent internal components of the telephone include a Main Control Unit (MCU) 803, a Digital Signal Processor (DSP) 805, and a receiver/transmitter unit including a microphone gain control unit and a speaker gain control unit. A main display unit 807 provides a display to the user in support of various applications and mobile station functions. An audio function circuitry 809 includes a microphone 811 and microphone amplifier that amplifies the speech signal output from the microphone 811. The amplified speech signal output from the microphone 811 is fed to a coder/decoder (CODEC) 813.

A radio section 815 amplifies power and converts frequency in order to communicate with a base station, which is included in a mobile communication system (e.g., systems of FIG. 7A or 7B), via antenna 817. The power amplifier (PA) 819 and the transmitter/modulation circuitry are operationally responsive to the MCU 803, with an output from the PA 819 coupled to the duplexer 821 or circulator or antenna switch, as known in the art. The PA 819 also couples to a battery interface and power control unit 820.

In use, a user of mobile station 801 speaks into the microphone 811 and his or her voice along with any detected background noise is converted into an analog voltage. The analog voltage is then converted into a digital signal through the Analog to Digital Converter (ADC) 823. The control unit 803 routes the digital signal into the DSP 805 for processing therein, such as speech encoding, channel encoding, encrypting, and interleaving. In the exemplary embodiment, the processed voice signals are encoded, by units not separately shown, using the cellular transmission protocol of Code Division Multiple Access (CDMA), as described in detail in the Telecommunication Industry Association's TIA/EIA/IS-95-A Mobile Station-Base Station Compatibility Standard for Dual-Mode Wideband Spread Spectrum Cellular System; which is incorporated herein by reference in its entirety.

The encoded signals are then routed to an equalizer 825 for compensation of any frequency-dependent impairments that occur during transmission though the air such as phase and amplitude distortion. After equalizing the bit stream, the modulator 827 combines the signal with a RF signal generated in the RF interface 829. The modulator 827 generates a sine wave by way of frequency or phase modulation. In order to prepare the signal for transmission, an up-converter 831 combines the sine wave output from the modulator 827 with another sine wave generated by a synthesizer 833 to achieve the desired frequency of transmission. The signal is then sent through a PA 819 to increase the signal to an appropriate power level. In practical systems, the PA 819 acts as a variable gain amplifier whose gain is controlled by the DSP 805 from information received from a network base station. The signal is then filtered within the duplexer 821 and optionally sent to an antenna coupler 835 to match impedances to provide maximum power transfer. Finally, the signal is transmitted via antenna 817 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile station 801 are received via antenna 817 and immediately amplified by a low noise amplifier (LNA) 837. A down-converter 839 lowers the carrier frequency while the demodulator 841 strips away the RF leaving only a digital bit stream. The signal then goes through the equalizer 825 and is processed by the DSP 805. A Digital to Analog Converter (DAC) 843 converts the signal and the resulting output is transmitted to the user through the speaker 845, all under control of a Main Control Unit (MCU) 803—which can be implemented as a Central Processing Unit (CPU) (not shown).

The MCU 803 receives various signals including input signals from the keyboard 847. The MCU 803 delivers a display command and a switch command to the display 807 and to the speech output switching controller, respectively. Further, the MCU 803 exchanges information with the DSP 805 and can access an optionally incorporated SIM card 849 and a memory 851. In addition, the MCU 803 executes various control functions required of the station. The DSP 805 may, depending upon the implementation, perform any of a variety of conventional digital processing functions on the voice signals. Additionally, DSP 805 determines the background noise level of the local environment from the signals detected by microphone 811 and sets the gain of microphone 811 to a level selected to compensate for the natural tendency of the user of the mobile station 801.

The CODEC 813 includes the ADC 823 and DAC 843. The memory 851 stores various data including call incoming-tone data and is capable of storing other data including music data received via, e.g., the global Internet. The software module could reside in RAM memory, flash memory, registers, or any other form of writable storage medium known in the art. The memory device 851 may be, but not limited to, a single memory, CD, DVD, ROM, RAM, EEPROM, optical storage, or any other non-volatile storage medium capable of storing digital data.

An optionally incorporated SIM card 849 carries, for instance, important information, such as the cellular phone number, the carrier supplying service, subscription details, and security information. The SIM card 849 serves primarily to identify the mobile station 801 on a radio network. The card 849 also contains a memory for storing a personal telephone number registry, text messages, and user specific mobile station settings.

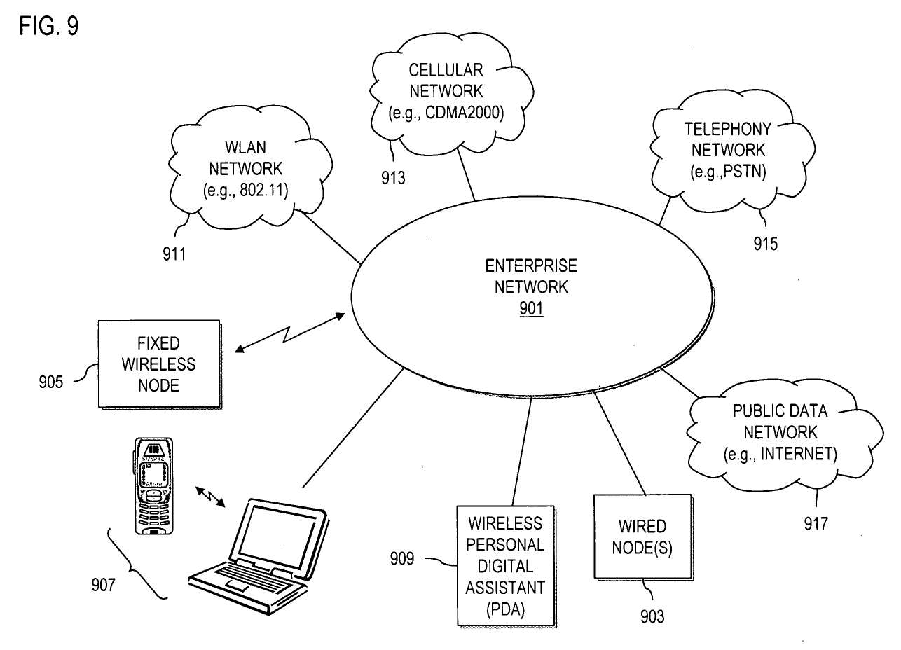

FIG. 9 shows an exemplary enterprise network, which can be any type of data communication network utilizing packet-based and/or cell-based technologies (e.g., Asynchronous Transfer Mode (ATM), Ethernet, IP-based, etc.). The enterprise network 901 provides connectivity for wired nodes 903 as well as wireless nodes 905, 907 and 909 (fixed or mobile), which are each configured to perform the processes described above. The enterprise network 901 can communicate with a variety of other networks, such as a WLAN network 911 (e.g., IEEE 802.11), a cdma2000 cellular network 913, a telephony network 915 (e.g., PSTN), or a public data network 917 (e.g., Internet).

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method comprising:
monitoring, while connected to a multi-carrier communication system, a control channel supported over one of a plurality of carriers,
wherein the one carrier is pre-designated as a primary carrier for the control channel.

2. A method according to claim 1, further comprising:
receiving a control message over the control channel, wherein the control message specifies whether a forward traffic channel is valid.

3. A method according to claim 1, further comprising:
receiving a control message over the control channel, wherein the control message specifies a silence period of a reverse link.

4. A method according to claim 1, wherein the multi-carrier communication system is cellular system including a plurality of sectors, the method further comprising:
receiving a sector parameter message over the control channel, wherein the sector parameter message specifies information about one of the sectors.

5. A method according to claim 4, wherein the sector parameter message includes either one of,
a field for identifying that a message type is the sector parameter message,
a field for indicating country code corresponding to the one sector,
a field for identifying the one sector,
a field for identifying subnet of the one sector,
a field for indicating change in content of the sector parameter message,
a field for providing location of the one sector,
a field for providing distance route update information,
a field for indicating number of leap seconds since start of system time of the communication system,
a field for indicating offset of local time from system time,
a field for specifying a silence period of a reverse link supported by the one sector,
a field for indicating duration of the reverse link silence period in units of frames,
a field for specifying number of channels available on the one sector,
a field for providing channel record specification,
a field for indicating number of records specifying information of neighboring sectors of the one sector,
a field for indicating Pseudo-Noise (PN) offset of a neighboring sector of the one sector,
a field for specifying whether a channel record of a particular neighboring sector of the one sector is included,
a field for specifying the channel record of the particular neighboring sector of the one sector,
a field for specifying whether search window sizes of neighboring sectors of the one sector are included,
a field for specifying values of the search window sizes,
a field for specifying whether search window size offsets of neighboring sectors of the one sector are included,
a field for specifying values of the search window size offsets,
a field for specifying whether parameters corresponding to the carriers are included,
a field for specifying number of the carriers that are included, or
a field for specifying channel information of the carriers that are included.

6. A method according to claim 1, further comprising:
receiving a configuration message over the control channel, wherein the configuration message specifies change in overhead information about the communication system.

7. A method according to claim 6, wherein the configuration parameter message includes either one of,
a field for identifying that a message type is the configuration message,
a field for indicating color code corresponding to the one sector,
a field for indicating maximum number of reverse power control channels supported by the one sector,
a field for providing supervision of a forward traffic channel to determine whether corresponding the forward traffic channel is valid,
a field for specifying whether parameters corresponding to the carriers are included,
a field for specifying number of the carriers that are included, or
a field for specifying channel information of the carriers that are included.

8. An apparatus comprising:
a processor configured to monitor, while connected to a multi-carrier communication system, a control channel supported over one of a plurality of carriers,
wherein the one carrier is pre-designated as a primary carrier for the control channel.

9. An apparatus according to claim 8, further comprising:
a transceiver configured to receive a control message over the control channel, wherein the control message specifies whether a forward traffic channel is valid.

10. An apparatus according to claim 8, further comprising:
a transceiver configured to receive a control message over the control channel, wherein the control message specifies a silence period of a reverse link.

11. An apparatus according to claim 8, wherein the multi-carrier communication system is cellular system including a plurality of sectors, the apparatus further comprising:
a transceiver configured to receive a sector parameter message over the control channel,
wherein the sector parameter message specifies information about one of the sectors.

12. An apparatus according to claim 11, further comprising:
memory configured to store the sector parameter message, wherein the sector parameter message includes either one of,
a field for identifying that a message type is the sector parameter message,
a field for indicating country code corresponding to the one sector,
a field for identifying the one sector,
a field for identifying subnet of the one sector,
a field for indicating change in content of the sector parameter message,
a field for providing location of the one sector,
a field for providing distance route update information,
a field for indicating number of leap seconds since start of system time of the communication system,
a field for indicating offset of local time from system time,
a field for specifying a silence period of a reverse link supported by the one sector,
a field for indicating duration of the reverse link silence period in units of frames,
a field for specifying number of channels available on the one sector,
a field for providing channel record specification,
a field for indicating number of records specifying information of neighboring sectors of the one sector,
a field for indicating Pseudo-Noise (PN) offset of a neighboring sector of the one sector,
a field for specifying whether a channel record of a particular neighboring sector of the one sector is included,
a field for specifying the channel record of the particular neighboring sector of the one sector,
a field for specifying whether search window sizes of neighboring sectors of the one sector are included,
a field for specifying values of the search window sizes,
a field for specifying whether search window size offsets of neighboring sectors of the one sector are included,
a field for specifying values of the search window size offsets,
a field for specifying whether parameters corresponding to the carriers are included,
a field for specifying number of the carriers that are included, or
a field for specifying channel information of the carriers that are included.

13. An apparatus according to claim 8, further comprising:
a transceiver configured to receive a configuration message over the control channel, wherein the configuration message specifies change in overhead information about the communication system.

14. An apparatus according to claim 13, further comprising:
memory configured to store the sector parameter message, wherein the configuration parameter message includes either one of,
a field for identifying that a message type is the configuration message,
a field for indicating color code corresponding to the one sector,
a field for indicating maximum number of reverse power control channels supported by the one sector,
a field for providing supervision of a forward traffic channel to determine whether corresponding the forward traffic channel is valid,
a field for specifying whether parameters corresponding to the carriers are included,
a field for specifying number of the carriers that are included, or
a field for specifying channel information of the carriers that are included.

15. A system comprising the apparatus of claim 8, the system comprising:
a keyboard configured to receive input from a user to initiate communication over the multi-carrier communication system; and
a display configured to display the input.

16. A method comprising:
designating, within a multi-carrier communication system, one of a plurality of carriers as a primary carrier for supporting a control channel,
wherein an access terminal is configured to monitor the control channel to obtain supervisory information.

17. A method according to claim 16, further comprising:
transmitting a control message over the control channel to the terminal, wherein the control message specifies whether a forward traffic channel is valid.

18. A method according to claim 16, further comprising:
transmitting a control message over the control channel to the terminal, wherein the control message specifies a silence period of a reverse link.

19. A method according to claim 16, wherein the multi-carrier communication system is cellular system including a plurality of sectors, the method further comprising:
transmitting a sector parameter message over the control channel to the terminal, wherein the sector parameter message specifies information about one of the sectors.

20. A method according to claim 19, wherein the sector parameter message includes either one of,
a field for identifying that a message type is the sector parameter message,
a field for indicating country code corresponding to the one sector,
a field for identifying the one sector,
a field for identifying subnet of the one sector,
a field for indicating change in content of the sector parameter message,
a field for providing location of the one sector,
a field for providing distance route update information,
a field for indicating number of leap seconds since start of system time of the communication system,
a field for indicating offset of local time from system time,
a field for specifying a silence period of a reverse link supported by the one sector,
a field for indicating duration of the reverse link silence period in units of frames,
a field for specifying number of channels available on the one sector,
a field for providing channel record specification,
a field for indicating number of records specifying information of neighboring sectors of the one sector,
a field for indicating Pseudo-Noise (PN) offset of a neighboring sector of the one sector,
a field for specifying whether a channel record of a particular neighboring sector of the one sector is included,
a field for specifying the channel record of the particular neighboring sector of the one sector,
a field for specifying whether search window sizes of neighboring sectors of the one sector are included,
a field for specifying values of the search window sizes,
a field for specifying whether search window size offsets of neighboring sectors of the one sector are included,
a field for specifying values of the search window size offsets,
a field for specifying whether parameters corresponding to the carriers are included,
a field for specifying number of the carriers that are included, or
a field for specifying channel information of the carriers that are included.

21. A method according to claim 16, further comprising:
transmitting a configuration message over the control channel to the terminal, wherein the configuration message specifies change in overhead information about the communication system.

22. A method according to claim 21, wherein the configuration parameter message includes either one of,
a field for identifying that a message type is the configuration message,
a field for indicating color code corresponding to the one sector,
a field for indicating maximum number of reverse power control channels supported by the one sector,
a field for providing supervision of a forward traffic channel to determine whether corresponding the forward traffic channel is valid,
a field for specifying whether parameters corresponding to the carriers are included,
a field for specifying number of the carriers that are included, or
a field for specifying channel information of the carriers that are included.

23. An apparatus comprising:
a processor configured to designate, within a multi-carrier communication system, one of a plurality of carriers as a primary carrier for supporting a control channel,
wherein an access terminal is configured to monitor the control channel to obtain supervisory information.

24. An apparatus according to claim 23, further comprising:
a transceiver configured to transmit a control message over the control channel to the terminal, wherein the control message specifies whether a forward traffic channel is valid.

25. An apparatus according to claim 23, further comprising:
a transceiver configured to transmit a control message over the control channel to the terminal, wherein the control message specifies a silence period of a reverse link.

26. An apparatus according to claim 23, wherein the multi-carrier communication system is cellular system including a plurality of sectors, the apparatus further comprising:
a transceiver configured to transmit a sector parameter message over the control channel to the terminal, wherein the sector parameter message specifies information about one of the sectors.

27. An apparatus according to claim 26, wherein the sector parameter message includes either one of,
a field for identifying that a message type is the sector parameter message,
a field for indicating country code corresponding to the one sector,
a field for identifying the one sector,
a field for identifying subnet of the one sector,
a field for indicating change in content of the sector parameter message,
a field for providing location of the one sector,
a field for providing distance route update information,
a field for indicating number of leap seconds since start of system time of the communication system,
a field for indicating offset of local time from system time,
a field for specifying a silence period of a reverse link supported by the one sector,
a field for indicating duration of the reverse link silence period in units of frames,
a field for specifying number of channels available on the one sector,
a field for providing channel record specification,
a field for indicating number of records specifying information of neighboring sectors of the one sector,
a field for indicating Pseudo-Noise (PN) offset of a neighboring sector of the one sector,
a field for specifying whether a channel record of a particular neighboring sector of the one sector is included,
a field for specifying the channel record of the particular neighboring sector of the one sector,
a field for specifying whether search window sizes of neighboring sectors of the one sector are included,
a field for specifying values of the search window sizes,
a field for specifying whether search window size offsets of neighboring sectors of the one sector are included,
a field for specifying values of the search window size offsets,
a field for specifying whether parameters corresponding to the carriers are included,
a field for specifying number of the carriers that are included, or
a field for specifying channel information of the carriers that are included.

28. An apparatus according to claim 23, further comprising:
transmitting a configuration message over the control channel to the terminal, wherein the configuration message specifies change in overhead information about the communication system.

29. An apparatus according to claim 28, wherein the configuration parameter message includes either one of,
a field for identifying that a message type is the configuration message,
a field for indicating color code corresponding to the one sector,
a field for indicating maximum number of reverse power control channels supported by the one sector,
a field for providing supervision of a forward traffic channel to determine whether corresponding the forward traffic channel is valid,
a field for specifying whether parameters corresponding to the carriers are included,
a field for specifying number of the carriers that are included, or
a field for specifying channel information of the carriers that are included.

30. A system comprising the apparatus of claim 23.

31. A method comprising:
establishing communication with a cellular communication system configured to provide high data rate service utilizing a plurality of carriers, wherein a single one of the carriers is designated for providing control channel supervision; and
receiving, during a connected state, a control channel message transmitted via the single carrier.

32. A method according to claim 31, wherein the control channel message specifies a silence period of a reverse link or whether a forward traffic channel is valid.

33. An apparatus comprising:
means for establishing communication with a cellular communication system configured to provide high data rate service utilizing a plurality of carriers, wherein a single one of the carriers is designated for providing control channel supervision; and
means for receiving, during a connected state, a control channel message transmitted via the single carrier.

34. An apparatus according to claim 33, wherein the control channel message specifies a silence period of a reverse link or whether a forward traffic channel is valid.
